(19) United States
(12) Patent Application Publication
(10) Pub. No.: US 2026/0196234 A1
(43) Pub. Date: Jul. 9, 2026

(54) ELECTRONIC DEVICE AND METHOD FOR SOUND OBJECT SEPARATION

(71) Applicant: Samsung Electronics Co., Ltd., Suwon-si (KR)

(72) Inventors: Dongwoo KIM, Suwon-si (KR); Inwoo HWANG, Suwon-si (KR); Hyeonsik JEONG, Suwon-si (JP); Yoonjae LEE, Suwon-si (KR); Hanki KIM, Suwon-si (KR); Sunmin KIM, Suwon-si (KR); Dowon KIM, Suwon-si (KR)

(21) Appl. No.: 19/455,529

(22) Filed: Jan. 21, 2026

Related U.S. Application Data
(63) Continuation of application No. PCT/KR2025/023129, filed on Dec. 30, 2025.

(30) Foreign Application Priority Data
Jan. 3, 2025 (KR) 10-2025-0001002

(51) Int. Cl. G10L 21/0272

(52) U.S. Cl. CPC G10L 21/0272

(57) ABSTRACT

A method of operating an electronic device may include: pre-processing input audio data to obtain input data of an object separation model; inputting the input data to the object separation model to obtain mask data for a plurality of objects and generating object audio data for the plurality of objects using the mask data for the plurality of objects. The pre-processing may include converting the input audio data to the frequency domain to obtain first frequency domain data having a first number of frequency bins and converting the first frequency domain data to second frequency domain data having a second number of frequency bins less than the first number of frequency bins using a designated conversion algorithm. The second frequency domain data may be input to the object separation model as the input data.

### CROSS-REFERENCE TO RELATED APPLICATIONS

This application is a continuation of International Application No. PCT/KR2025/023129 designating the United States, filed on Dec. 30, 2025, in the Ministry of Intellectual Property Receiving Office and claiming priority to Korean Patent Application No. 10-2025-0001002, filed on Jan. 3, 2025, in the Ministry of Intellectual Property, the disclosures of each of which are incorporated by reference herein in their entireties.

### BACKGROUND

### Field

The disclosure relates to an electronic device and method for sound object separation.

### Description of Related Art

With technological advancement (e.g., advancement of AI technology), techniques for separating human voice from background sound or separating instrument sounds from music have been proposed. Such sound separation technology enables new sound rendering methods.

However, most sound separation technologies rely on server-based models, and while these models have excellent performance, implementation in an on-device environment is difficult due to constraints such as model size and input data size. Further, sound separation models mainly use non-causal structures that utilize future data to achieve high performance, resulting in a lack of real-time capability. Therefore, a sound separation technology that ensures real-time capability and is capable of on-device implementation is needed.

The above-described information may be provided as related art for the purpose of aiding in understanding of the disclosure. No assertion or determination is made as to whether any of the foregoing is applicable as background art in relation to the disclosure.

### SUMMARY

According to an example embodiment of the disclosure, an electronic device may include: a memory including at least one storage medium storing instructions and at least one processor, comprising processing circuitry, wherein at least one processor, individually and/or collectively, may be configured to cause the electronic device to: pre-process input audio data to obtain input data of an object separation model, input the input data to the object separation model to obtain mask data for a plurality of objects, and generate object audio data for the plurality of objects using the mask data for the plurality of objects. The pre-processing of the input audio data may include: converting the input audio data to a frequency domain to obtain first frequency domain data having a first number of frequency bins and converting the first frequency domain data to second frequency domain data having a second number of frequency bins less than the first number of frequency bins using a designated (or, specified) conversion algorithm. The second frequency domain data may be input to the object separation model as the input data.

According to an example embodiment of the disclosure, a method of operating an electronic device may include: pre-processing input audio data to obtain input data of an object separation model; inputting the input data to the object separation model to obtain mask data for a plurality of objects and generating object audio data for the plurality of objects using the mask data for the plurality of objects. The pre-processing of the input audio data may include: converting the input audio data to a frequency domain to obtain first frequency domain data having a first number of frequency bins and converting the first frequency domain data to second frequency domain data having a second number of frequency bins less than the first number of frequency bins using a designated (or, specified) conversion algorithm. The second frequency domain data may be input to the object separation model as the input data.

According to an example embodiment, the converting to the second frequency domain data may include applying a second frequency resolution higher than a first frequency resolution to frequency bins having a frequency equal to or higher than a reference frequency among frequency bins of the first frequency domain data. The first frequency resolution may be a frequency resolution applied to frequency bins having a frequency lower than the reference frequency among the frequency bins of the first frequency domain data.

According to an example embodiment, the converting to the second frequency domain data may include applying a designated (or, specified) conversion function to frequency bins having a frequency equal to or higher than a reference frequency among frequency bins of the first frequency domain data. The conversion function may be set based on the reference frequency, the first number of frequency bins, the second number of frequency bins, and a first frequency resolution. The first frequency resolution may be set to a value obtained by dividing a sampling rate of the input audio data by a fast Fourier transform (FFT) size.

According to an example embodiment, the reference frequency may be set based on a frequency band of a first object corresponding to voice among the plurality of objects.

According to an example embodiment, FFT may be used for the conversion to the frequency domain, the first number of frequency bins may be half of an FFT size of the FFT, and the second number of frequency bins may be half of the first number of frequency bins.

According to an example embodiment, the object separation model may correspond to a U-Net model using a skip connection structure. The skip connection structure may include a structure in which an output value of each stage of an encoder is connected to a corresponding stage of a decoder.

According to an example embodiment, the object separation model may have a single input/output structure.

According to an example embodiment, the object separation model may include at least one one-dimensional (1D) convolution layer, at least one 1D-transpose (1D-Tr) convolution layer, and a long short-term memory (LSTM) layer.

According to an example embodiment, the object separation model may be an on-device model stored in the memory, and a time duration of the input audio data may be set to a value smaller than 50 ms.

According to an example embodiment, the generating of the object audio data for the plurality of objects may include recovering each mask data having the second number of frequency bins using a designated (or, specified) recovery algorithm to obtain each recovered mask data having the first number of frequency bins; and multiplying the first frequency domain data by each of the recovered mask data to generate the object audio data for the plurality of objects respectively. The plurality of objects may include at least one of a first object corresponding to voice, a second object corresponding to music, or a third object corresponding to effect.

According to an example embodiment, an electronic device may ensure real-time capability using an object separation model having a single input/output structure and/or a causal structure. According to an example embodiment, an electronic device may be implemented as an on-device model by reducing the model size of the object separation model and/or the input data size in time and frequency axes.

The disclosure is not limited to the foregoing examples but various modifications or changes may be made thereto without departing from the spirit and scope of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments.

FIG. 2 is a diagram illustrating an example configuration of an electronic device according various embodiments.

FIG. 3 is a flowchart illustrating an example object separation method according to various embodiments.

FIG. 4 is a flowchart illustrating an example operation of generating model input data used for the object separation method of FIG. 3 according to various embodiments.

FIG. 5 is a graph illustrating a conversion function for generating the model input data of FIG. 4 according to various embodiments.

FIG. 6 is a diagram illustrating an example object separation model according to various embodiments.

FIG. 7 is a diagram illustrating an example internal configuration of an object separation model according to various embodiments.

FIG. 8 is a diagram illustrating an example internal configuration of an object separation model according to various embodiments.

FIG. 9 is a diagram illustrating an example internal configuration of an object separation model according to various embodiments.

FIG. 10 is a diagram illustrating an example method for an electronic device to use separated object audio data according to various embodiments.

Reference may be made to the accompanying drawings in the following description, and various examples that may be practiced are shown as examples within the drawings. Other examples may be utilized and structural changes may be made without departing from the scope of the disclosure.

### DETAILED DESCRIPTION

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

Embodiments of the disclosure and terms used therein are not intended to limit the technical features described in the disclosure to specific embodiments, and should be understood to include various modifications, equivalents, or substitutes of the various embodiments. With regard to the description of the drawings, similar reference numerals may be used to refer to similar or related elements. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

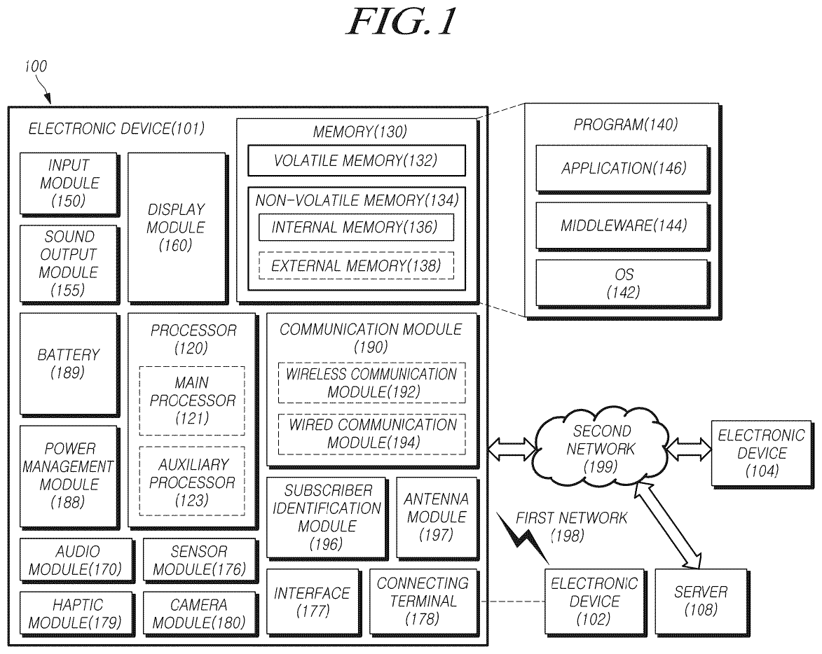

FIG. 1 is a block diagram illustrating an example electronic device in a network environment according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, each processor 120 or “model” herein may include processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, e.g., a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multiple components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197. According to an embodiment, the antenna module 197 may form a mmWave antenna module. According to an embodiment, the mm Wave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

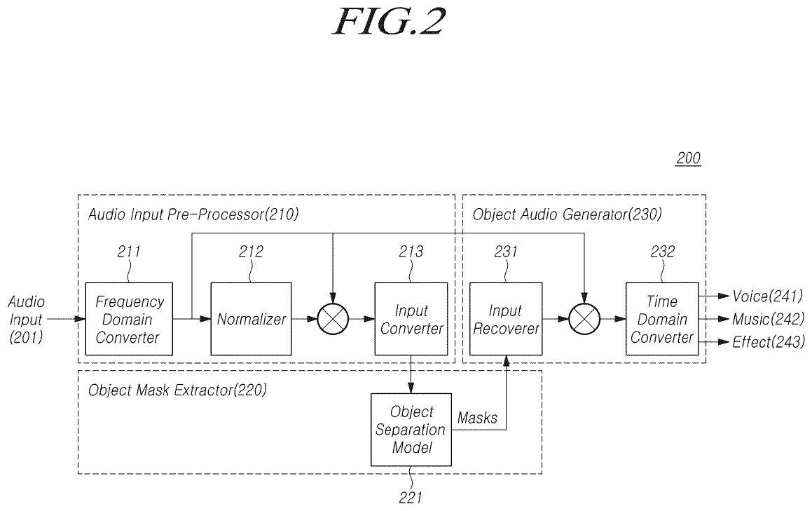

FIG. 2 is a block diagram illustrating an example configuration of an electronic device according to various embodiments.

According to an embodiment, an electronic device 200 (e.g., the electronic device 101 of FIG. 1) may obtain object audio data 241, 242, 243 for a plurality of objects from input sound data (e.g., input audio data 201) using an object separation model 221. In the disclosure, for convenience of description, the input sound data is described as being input audio data 201, but the disclosure is not limited thereto. For example, various types of sound data may be used for object separation.

According to an embodiment, the object separation model 221 may include various circuitry and/or executable program instructions and may include, e.g., a model used to obtain mask data for a plurality of objects from the input audio data 201. The object separation model 221 may be, e.g., an artificial intelligence (AI) model trained to receive input data in the frequency domain generated based on the input audio data 201 and output mask data for a plurality of objects. The object separation model 221 may be, e.g., a convolution-based AI model (e.g., neural network model) in the frequency domain.

According to an embodiment, the mask data may be, e.g., data serving as a filter used to separate object audio data for a plurality of objects from input audio data. The mask data may be, e.g., in the form of a tensor (or matrix) having values between 0 and 1.

Referring to FIG. 2, the electronic device 200 may include an audio input pre-processor 210, an object mask extractor 220, and/or an object audio generator 230. According to an embodiment, the electronic device 200 may be a multimedia device or display device that processes and/or outputs sound signals. For example, the electronic device 200 may be a multimedia device such as a TV, smartphone, tablet, notebook, desktop, monitor, sound bar, Bluetooth speaker, home theater system, projector, electronic whiteboard, or streaming device, but the disclosure is not limited thereto.

According to an embodiment, the audio input pre-processor 210 may pre-process the input audio data 201 (or signal) to obtain (or generate) input data of the object mask extractor 220 (or the object separation model 221). In the disclosure, the input audio data may be referred to as original audio data.

According to an embodiment, the audio input pre-processor 210 may be implemented by at least one processor (e.g., the processor 120 of FIG. 1). For example, each component of the audio input pre-processor 210 may be implemented by a digital signal processor (DSP).

According to an embodiment, the audio input pre-processor 210 may include a frequency domain converter 211, a normalizer 212, and/or an input converter 213, each of which may include various circuitry and/or executable program instructions.

According to an embodiment, the frequency domain converter 211 may convert the input audio data 201 to the frequency domain to obtain first frequency domain data having a first number of frequency bins. For example, the frequency domain converter 211 may convert the input audio data 201 to the frequency domain by applying FFT to the input audio data. According to an embodiment, the input audio data 201 may be audio data having a sampling rate of 48 KHz. According to an embodiment, the input audio data 201 may be audio data set to a designated time duration (e.g., 50 ms) or less. In case that the input audio data 201 having such a limited time duration is used for object separation, the time axis size (length) of data input to the object separation model 221 may be decreased. Accordingly, the size of the object separation model 221 may be decreased.

According to an embodiment, the first number of frequency bins may be half of the FFT size. For example, in case that the FFT size is 2048, the first number of frequency bins may be 1024. The FFT size may be the number of FFT-points.

According to an embodiment, the normalizer 212 may perform normalization on the first frequency domain data to obtain normalized first frequency domain data. For example, the normalizer 212 may perform normalization on the first frequency domain data using a per-channel energy normalization (PCEN) technique. Accordingly, frequency domain data robust to noise may be obtained. According to an embodiment, the first frequency domain data may be multiplied with the normalized first frequency domain data through a multiplier (x) to obtain scaled first frequency domain data. Accordingly, important frequency components may be emphasized and unnecessary frequency components may be suppressed. In the disclosure, the normalized first frequency domain data and the scaled first frequency domain data may have the same first number of frequency bins as the first frequency domain data. In the disclosure, frequency domain data having the first number of frequency bins may be collectively referred to as first frequency domain data.

According to an embodiment, the input converter 213 may convert the first frequency domain data (e.g., scaled first frequency domain data) to second frequency domain data having a second number of frequency bins smaller than the first number of frequency bins using a designated conversion algorithm. According to an embodiment, the second number of frequency bins (e.g., 512) may be half of the first number of frequency bins (e.g., 1024).

According to an embodiment, the input converter 213 may obtain the second frequency domain data having the second number of frequency bins by applying a second frequency resolution higher than a first frequency resolution to frequency bins having a frequency equal to or higher than a reference frequency among the frequency bins of the first frequency domain data. According to an embodiment, the first frequency resolution may be a frequency resolution applied to frequency bins having a frequency lower than the reference frequency among the frequency bins of the first frequency domain data. The first frequency resolution may be set to a value obtained by dividing the sampling rate of the input audio data (e.g., 48 kHz) by the FFT size (e.g., 2048).

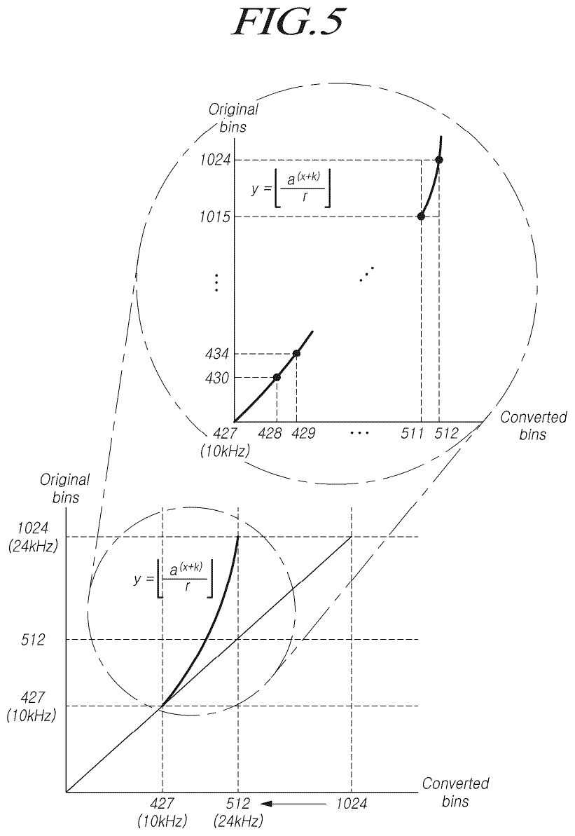

According to an embodiment, the input converter 213 may obtain the second frequency domain data having the second number of frequency bins by applying a designated conversion function to frequency bins having a frequency equal to or higher than a reference frequency among the frequency bins of the first frequency domain data. According to an embodiment, the conversion function may be set based on the reference frequency, the first number of frequency bins, the second number of frequency bins, and/or the first frequency resolution. As described above, the first frequency resolution may be set to a value obtained by dividing the sampling rate of the input audio data (e.g., 48 kHz) by the FFT size (e.g., 2048). An example of the designated conversion function is described in greater detail below with reference to FIG. 5.

According to an embodiment, the reference frequency may be set based on a frequency band of a first object corresponding to voice among a plurality of objects extracted from the input audio data. For example, the reference frequency may be set to 10 kHz (or a frequency within a first range from 10 kHz). This is because most frequency components of the first object corresponding to voice do not exceed 10 kHz, so even in case that frequency domain data is converted by setting high frequency resolution in frequency bands above 10 kHz, it may not significantly affect the performance of object separation.

According to an embodiment, the second frequency domain data may be used as input data of the object mask extractor 220. For example, the second frequency domain data may be input to the object separation model 221 included in the object mask extractor 220. In case that the second frequency domain data with the decreased number of frequency bins is input to the object separation model 221, the frequency axis size (length) of the input data of the object separation model 221 may be decreased compared to the case that the first frequency domain data is directly input to the object separation model 221. This enables reduction of the model size of the object separation model 221. In the disclosure, data input to the object separation model 221 may be referred to as model input data.

According to an embodiment, the object mask extractor 220 may obtain mask data for a plurality of objects using the input data (e.g., second frequency domain data) transmitted from the audio input pre-processor 210. For example, the object mask extractor 220 may input the input data to the object separation model 221 and obtain mask data for a plurality of objects output from the object separation model 221. The mask data, as frequency domain data, may have the same second number of frequency bins as the second frequency domain data. The plurality of objects may include, e.g., at least one of a first object corresponding to voice, a second object corresponding to music, or a third object corresponding to effect.

According to an embodiment, the object mask extractor 220 may be implemented by at least one processor (e.g., the processor 120 of FIG. 1). For example, each component of the object mask extractor 220 may be implemented by a neural processing unit (NPU).

According to an embodiment, the object separation model 221 may be a U-Net model using a skip connection structure. The skip connection structure may be a structure in which an output value of each stage of an encoder is connected to a corresponding stage of a decoder. Through such a skip connection structure, the recovery performance of the decoder of the object separation model 221 may be enhanced.

According to an embodiment, the object separation model 221 may have a single input/output structure. By implementing an object separation model having a single input/output structure, real-time capability is ensured and easy on-device implementation may be possible.

According to an embodiment, the object separation model 221 may include, for example, and without limitation, at least one one-dimensional (1D) convolution layer, at least one 1D-transpose (1D-Tr) convolution layer, and/or an LSTM layer. The at least one 1D convolution layer may convolve and/or de-convolve only the frequency axis without convolving the time axis. The at least one 1D convolution layer may be used to compress and decompress only frequency axis information. The LSTM layer may store time axis information and learn the influence of a single input data of a short time (e.g., within 50 ms) input in real-time and past input data previously input. Through such an LSTM layer, the time axis size (length) of input data may be decreased. By implementing the object separation model 221 with 1D convolution layers, 1D-Tr convolution layers, and LSTM layers, a model having a single input/output structure and capable of on-device implementation may be realized.

According to an embodiment, the object separation model 221 may be an on-device model stored in the memory (e.g., the memory 130 of FIG. 1) of the electronic device, but the disclosure is not limited thereto. For example, as necessary, the object separation model 221 may also be a model stored in a server (e.g., the server 108 of FIG. 1).

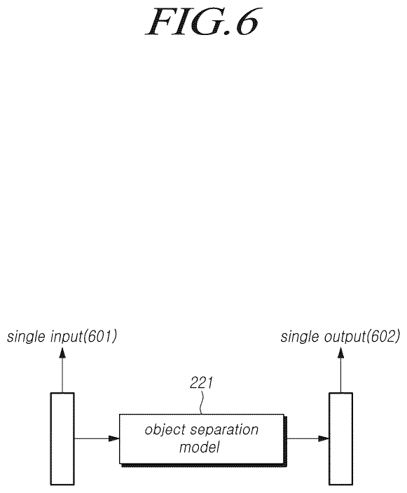

The object separation model 221 having the above-described characteristic(s) ensures real-time capability and may be capable of easy on-device implementation compared to a model (e.g., Demucs (deep extractor for music sources) model) that uses long past input data (e.g., input data of 3 seconds or more) and includes 2D convolution layers and transformers. A description of an example of such an object separation model 221 is made in greater detail below with reference to FIGS. 6 to 9.

According to an embodiment, the object audio generator 230 may generate object audio data for a plurality of objects using the mask data for the plurality of objects transmitted from the object mask extractor 220.

According to an embodiment, the object audio generator 230 may be implemented by at least one processor (e.g., the processor 120 of FIG. 1, the description above of which applies equally here). For example, each component of the object audio generator 230 may be implemented by a DSP.

According to an embodiment, the object audio generator 230 may include an input recoverer 231 and/or a time domain converter 232, each of which may include various circuitry and/or executable program instructions.

According to an embodiment, the input recoverer 231 may recover each mask data having the second number of frequency bins (e.g., 512) using a designated recovery algorithm to obtain each recovered mask data having the first number of frequency bins (e.g., 1024) greater than the second number of frequency bins. The designated recovery algorithm may be, e.g., an algorithm for performing the inverse operation of the designated conversion algorithm. Accordingly, the frequency axis size (length) decreased for input to the object separation model 221 may be recovered to the original frequency axis size (length).

According to an embodiment, each recovered mask data may be multiplied with the first frequency domain data through a multiplier (x) to generate frequency domain object audio data for a plurality of objects respectively.

According to an embodiment, the time domain converter 232 may convert each frequency domain object audio data to the time domain to obtain each time domain object audio data. For example, the time domain converter 232 may convert each frequency domain object audio data to the time domain by applying inverse FFT (IFFT) to each frequency domain object audio data. Each time domain object audio data may have the same time duration as the time duration of the input audio data (e.g., 42.6 ms). The operation of the time domain converter 232 (e.g., the IFFT application operation of the time domain converter 232) may be the inverse operation of the operation of the frequency domain converter 211 (e.g., the FFT application operation of the frequency domain converter 211). Accordingly, the original input audio data 201 may be completely separated into object audio data 241, 242, 243 of each object. For example, the input audio data 201 may be separated into object audio data 241 corresponding to a voice object, object audio data 242 corresponding to a music object, and object audio data 243 corresponding to an effect object. In this manner, single object audio signal(s) for a single input audio signal may be separated in real-time.

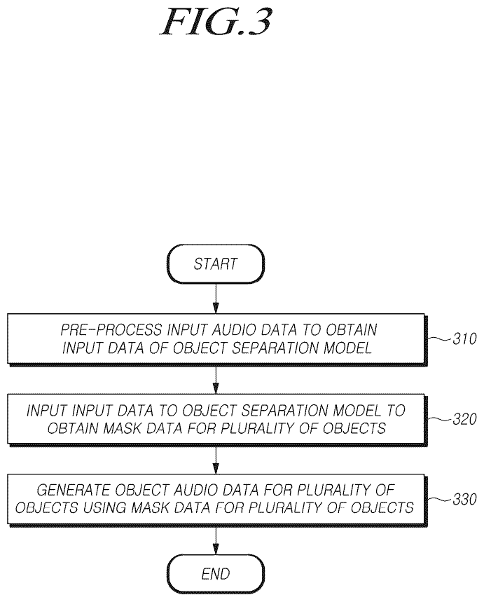

FIG. 3 is a flowchart illustrating an example object separation method according to various embodiments.

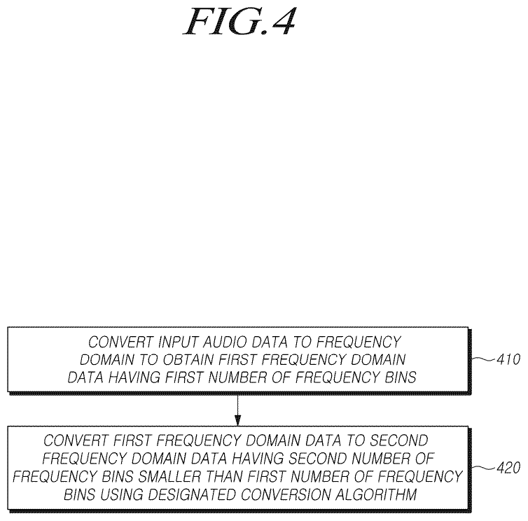

FIG. 4 is a flowchart illustrating an example operation of generating model input data used for the object separation method of FIG. 3 according to various embodiments.

FIG. 5 is a graph illustrating a conversion function for generating the model input data of FIG. 4 according to various embodiments.

Referring to FIGS. 3 to 5, in operation 310, an electronic device (e.g., the electronic device 101 of FIG. 1, the electronic device 200 of FIG. 2) may pre-process input audio data to obtain input data of an object separation model (e.g., the object separation model 221 of FIG. 2). According to an embodiment, operation 310 may be performed by an audio input pre-processor (e.g., the audio input pre-processor 210 of FIG. 2) and may include all or some of the above-described operations performed by each component of the audio input pre-processor.

According to an embodiment, the pre-processing of the input audio data in operation 310 may include an operation 410 of converting the input audio data to the frequency domain to obtain first frequency domain data having a first number of frequency bins and/or an operation 420 of converting the first frequency domain data to second frequency domain data having a second number of frequency bins smaller than the first number of frequency bins using a designated conversion algorithm. According to an embodiment, FFT may be used for the conversion to the frequency domain, the first number of frequency bins (e.g., 1024) may be half of the FFT size (e.g., 2048) of the FFT, and the second number of frequency bins (e.g., 512) may be half of the first number of frequency bins. The second frequency domain data with the decreased frequency axis length may be input to the object separation model as input data (model input data). Accordingly, the size of the input data of the object separation model and the model size may be decreased.

According to an embodiment, operation 410 may be performed by a frequency domain converter (e.g., the frequency domain converter 211 of FIG. 2). According to an embodiment, operation 420 may be performed by an input converter (e.g., the input converter 213 of FIG. 2).

According to an embodiment, the second frequency domain data having the second number of frequency bins may be obtained by applying a second frequency resolution higher than a first frequency resolution to frequency bins having a frequency equal to or higher than a reference frequency among the frequency bins of the first frequency domain data. The first frequency resolution may be a frequency resolution applied to frequency bins having a frequency lower than the reference frequency among the frequency bins of the first frequency domain data. The first frequency resolution may be set to a value obtained by dividing the sampling rate of the input audio data by the FFT size (e.g., 23.4 Hz=48 kHz/2048). According to an embodiment, the reference frequency may be set based on a frequency band of a first object corresponding to voice among the plurality of objects.

According to an embodiment, the electronic device may obtain the second frequency domain data having the second number of frequency bins by applying a designated conversion function to frequency bins having a frequency equal to or higher than a reference frequency among the frequency bins of the first frequency domain data. According to an embodiment, the conversion function may be set based on the reference frequency, the first number of frequency bins, and the first frequency resolution.

With reference to FIG. 5, an example of the conversion function and the conversion operation using the conversion function are described. For convenience of description, it is assumed that the first number of frequency bins is 1024, the second number of frequency bins is 512 which is half of the first number of frequency bins, and the reference frequency is 10 kHz. In this case, the conversion function may be applied from the frequency bin having index 427 corresponding to the frequency (or frequency band) of 10 kHz to the frequency bin having index 1024.

According to an embodiment, as illustrated in FIG. 5, the conversion function may have the form of an exponential function. For example, the conversion function may be as illustrated in Equation 1 below.

$$y = ⌊ \frac{{a}^{( x + k )}}{r} ⌋ \qquad [ Equation 1 ]$$

where,
x is the index value of the frequency bin (converted bin) of the second frequency domain data,
y is the index value of the frequency bin (original bin) of the first frequency domain data corresponding to the x value, where the converted bin corresponding to the original bin has the same frequency (or frequency band),
a is the base value of the exponential function,
k is the translation value, and
r is the frequency resolution, where the frequency resolution is the value obtained by dividing the sampling rate of the input audio data by the FFT size (e.g., 23.4 Hz=48000 Hz/2048).

According to an embodiment, the a value and k value may be set based on the reference frequency, the first number of frequency bins, the second number of frequency bins, and/or the frequency resolution. For example, to apply the conversion function from the frequency bin having index 427 corresponding to the reference frequency of 10 kHz to the frequency bin having index 1024 corresponding to 24 kHz among the frequency bins of the first frequency domain data, and to convert them respectively to frequency bins from the frequency bin having index 427 to the frequency bin having index 512, the a value may be set to 1.0104 and the k value may be set to 463. In this case, as illustrated in the extended portion of FIG. 5, the frequency bin of index 427, the frequency bin of index 434, . . . , the frequency bin of index 1015, and the frequency bin of index 1024 of the first frequency domain data may be converted respectively to the frequency bin of index 427, the frequency bin of index 428, . . . , the frequency bin of index 511, and the frequency bin of index 512 of the second frequency domain data. In this case, the frequency bin of index 427 of the second frequency domain data may correspond to a frequency (or frequency band) of 10 kHz, and the frequency bin of index 512 of the second frequency domain data may correspond to a frequency (or frequency band) of 24 kHz. Through this conversion process, the number of frequency bins is decreased, and the size of input data input to the object separation model may be decreased.

In operation 320, the electronic device may input the obtained input data to the object separation model (e.g., the object separation model 221 of FIG. 2) to obtain mask data for a plurality of objects. Operation 320 may include all or some of the above-described operations performed by each component of the object mask extractor (e.g., the object mask extractor 220 of FIG. 2).

According to an embodiment, the object separation model may correspond to a U-Net model using a skip connection structure. The skip connection structure may be a structure in which an output value of each stage of an encoder is connected to a corresponding stage of a decoder. According to an embodiment, the object separation model may have a single input/output structure. According to an embodiment, the object separation model may include at least one 1D convolution layer, at least one 1D-Tr convolution layer, and/or a long short-term memory (LSTM) layer. According to an embodiment, the object separation model may be an on-device model stored in memory. An example of the object separation model having the above-described feature(s) is described in greater detail below with reference to FIGS. 6 to 9.

In operation 330, the electronic device may generate object audio data for a plurality of objects using the mask data for the plurality of objects. Operation 330 may include all or some of the above-described operations performed by each component of the object audio generator (e.g., the object audio generator 230 of FIG. 2).

According to an embodiment, the electronic device may recover each mask data having the second number of frequency bins using a designated recovery algorithm to obtain each recovered mask data having the first number of frequency bins, and multiply the first frequency domain data by each of the recovered mask data to generate object audio data for the plurality of objects respectively. The plurality of objects may include at least one of a first object corresponding to voice, a second object corresponding to music, or a third object corresponding to effect.

FIG. 6 is a diagram illustrating an example object separation model according to various embodiments.

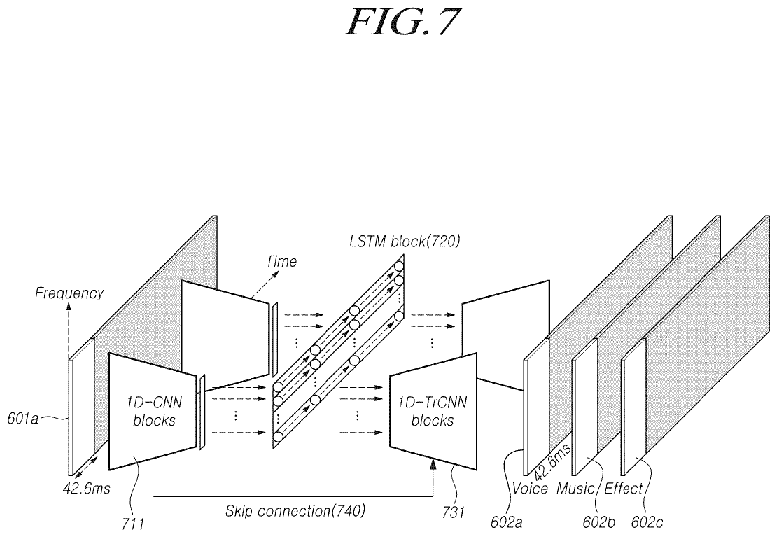

FIGS. 7 to 9 are diagrams illustrating an example internal configuration of an object separation model according to various embodiments.

Referring to FIGS. 6 to 9, according to an embodiment, the object separation model 221 may have a single input/output structure. For example, as illustrated in FIG. 6, the object separation model 221 may be a model that receives a single input 601 and outputs a single output 602. The single input 601 and the single output 602 may be set as a single frame having a designated time duration (e.g., a time duration of 50 ms or less) in the time domain. For example, as illustrated in FIG. 7, frequency domain data 601a for one frame (or one time step) (e.g., the second frequency domain data of FIG. 2) may be input to the object separation model 221 as the single input 601, and mask data 602a, 602b, 602c for the corresponding frame (e.g., mask data for a plurality of objects of FIG. 2) may be output as the single output 602. The mask data included in the single output 602 may include first mask data 602a corresponding to a voice object, second mask data 602b corresponding to a music object, and/or third mask data 602c corresponding to an effect object. The time duration of one frame (or one time step) may be the same as the time duration of the input audio data (e.g., time duration of 42.6 ms).

The object separation model 221 according to an embodiment of the disclosure may ensure real-time capability by being implemented to have a single input/output structure. For example, the object separation model 221 having a single input/output structure may ensure real-time capability compared to the case that the object separation model has a batch input/output structure including multiple inputs and multiple outputs (e.g., inputs and outputs set as multiple frames having a time duration of 3 seconds or more), or has an input/output structure that outputs a single output using input data including a current single input (single frame) and past inputs (multiple frames).

The object separation model 221 according to an embodiment of the disclosure may be easily implementable on-device by being implemented to have a single input/output structure using input/output data of a short time duration (e.g., time duration of one frame corresponding to 42.6 ms), which decreases the size (length) of model input data.

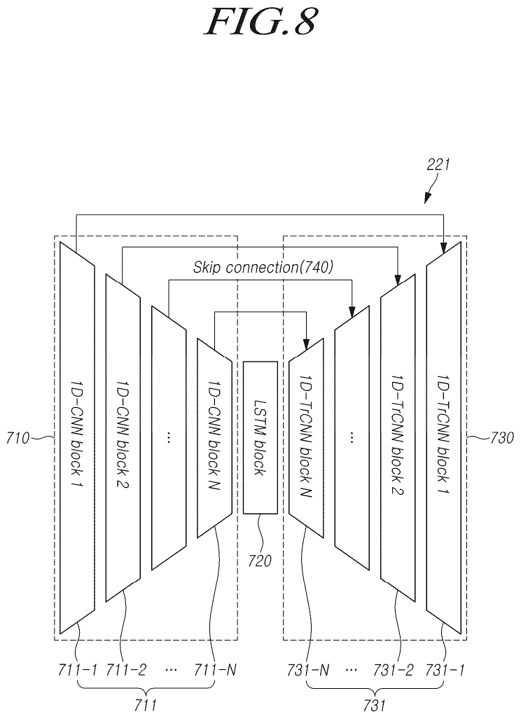

According to an embodiment, as illustrated in FIGS. 7 and 8, the object separation model 221 may include an encoder 710, an LSTM block 720, and/or a decoder 730.

According to an embodiment, the encoder 710 may extract and compress main features of frequency domain input data (e.g., the second frequency domain data of FIG. 2) using at least one 1D-CNN block 711 to obtain encoded data. For example, as illustrated in FIG. 8, the encoder 710 may sequentially apply N 1D-CNN blocks to the input data to progressively extract and compress main features of the input data. The 1D-CNN block may include at least one 1D convolution layer. Through such encoder processing (e.g., convolution processing on the frequency axis), frequency axis information rather than time axis information is compressed, and a high-level representation may be generated.

According to an embodiment, the LSTM block 720 may include at least one LSTM layer. The LSTM block 720 (or LSTM layer) may store time axis information. The LSTM block 720 (or LSTM layer) may include LSTM cells, process input data in the time-axis direction, and learn both long-term dependency and short-term dependency. For example, the LSTM block 720 (or LSTM layer) may learn the influence of single input data input in real-time and previously input past input data(s). Through implementation of the object separation model 221 using such an LSTM block 720, the time axis size (length) of input data may be decreased.

According to an embodiment, the decoder 730 may recover the encoded data using at least one 1D-Transpose CNN block 731. For example, as illustrated in FIG. 8, the decoder 730 may sequentially apply N 1D-TrCNN blocks to the encoded data to progressively recover the encoded data. The 1D-TrCNN block may include at least one 1D transpose convolution layer. Through such decoder processing (e.g., de-convolution processing on the frequency axis), the compressed encoded data may be recovered.

According to an embodiment, the object separation model 221 may be a model using a skip connection structure. The skip connection structure may be a structure in which an output value (output data) of each stage of an encoder is connected to a corresponding stage of a decoder. For example, as illustrated in FIGS. 7 and 8, the object separation model 221 may include a skip connection 740 in which the output value of each 1D-CNN block (711-1, 711-2, . . . , 711-N; 711) of the encoder 710 is connected to each corresponding 1D-TrCNN block (731-1, 731-2, . . . , 731-N; 731) of the decoder 730. In this case, each 1D-TrCNN block 731 may generate its output data by combining its input data with the output data of the corresponding 1D-CNN block 711. As an example, as illustrated in FIG. 8, the output data of 1D-CNN block 2 711-2 may be transmitted to 1D-TrCNN block 2 731-2 through the skip connection 740, and 1D-TrCNN block 2 731-2 may generate the output data of 1D-TrCNN block 2 731-2 by combining the input data of 1D-TrCNN block 2 731-2 with the output data of 1D-CNN block 2 711-2, and transmit the generated output data to 1D-TrCNN block 1 731-1. Through such skip connection 740, low-level features extracted at each stage (or block) of the encoder 710 are transmitted to the corresponding stage (or block) of the decoder 730, and each stage of the decoder 730 performs recovery operations using (e.g., concatenating) the low-level features transmitted from the encoder 710, thereby enhancing recovery performance.

The object separation model 221 according to an embodiment of the disclosure may be implemented as a model having a single input/output structure by being implemented as a model including at least one 1D convolution layer, at least one 1D-Tr convolution layer, and/or an LSTM layer.

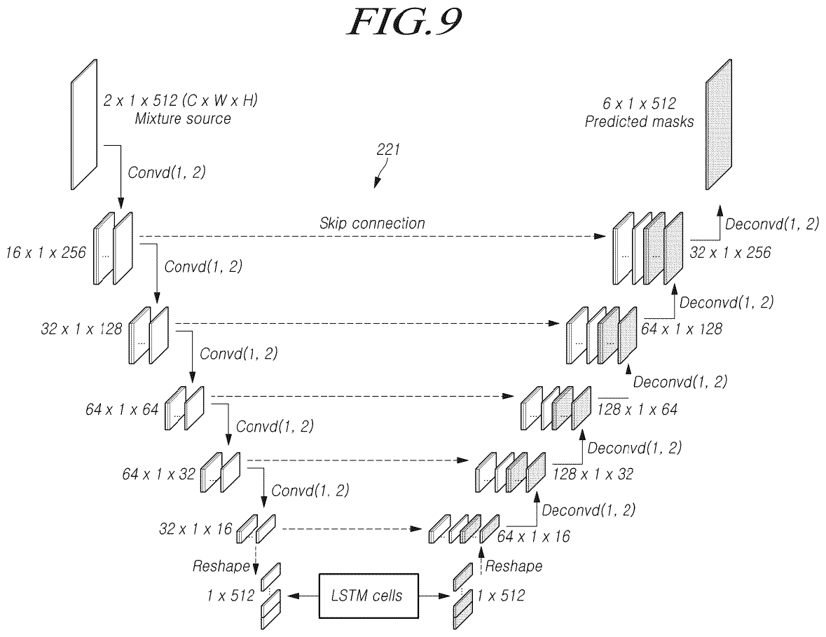

According to an embodiment, the object separation model 221 may be a U-Net model. For example, as illustrated in FIG. 9, the object separation model 221 may be a U-Net model having a skip connection 740 and a U-shape. The U-Net model may have all and/or some of the characteristics of the above-described object separation model 221. For example, the U-Net model may have a single input/output structure feature, a feature including 1D convolution layers and LSTM layers, and/or a feature using a skip connection structure.

The operation of the object separation model 221 of the U-Net model is described by way of non-limiting example in greater detail below with reference to FIG. 9. For convenience of description, an example is described in which the encoder and decoder include five 1D convolution layers, but the disclosure is not limited thereto.

Referring to FIG. 9, the object separation model 221 of the U-Net model may extract and compress main features on the frequency axis from frequency domain input data using an encoder including five 1D convolution layers. For example, as illustrated in FIG. 9, the encoder may compress on the frequency axis and generate high-level data by sequentially applying five 1D convolution layers corresponding to Convd(1,2) to input data of 2×1×512 (C×W×H) (where the input data corresponds to complex form so channel (C) is 2, corresponds to one time step so width (W) is 1, and corresponds to 512 frequency bins so height (H) is 512). The encoded data may be reshaped and transmitted to the LSTM layer. The data passing through the LSTM layer may be reshaped and input to the decoder. The object separation model 221 of the U-Net model may recover the encoded data using a decoder including five 1D-Tr convolution layers. In this case, the decoder may use low-level data transmitted from the encoder through skip connections for recovery. Accordingly, the decoder may output output data of 6×1×512 (C×W×H). The output data corresponds to mask data for three objects, where each mask data corresponds to complex form so channel (C) is 6 (=2*3), corresponds to one time step so width (W) is 1, and corresponds to 512 frequency bins so height (H) is 512.

According to an embodiment, the object separation model 221 may be an on-device model stored in the memory (e.g., the memory 130 of FIG. 1) of the electronic device.

The object separation model 221 having the above-described characteristic(s) ensures real-time capability and may be capable of easy on-device implementation compared to a model that uses long past input data and includes 2D convolution layers and transformers.

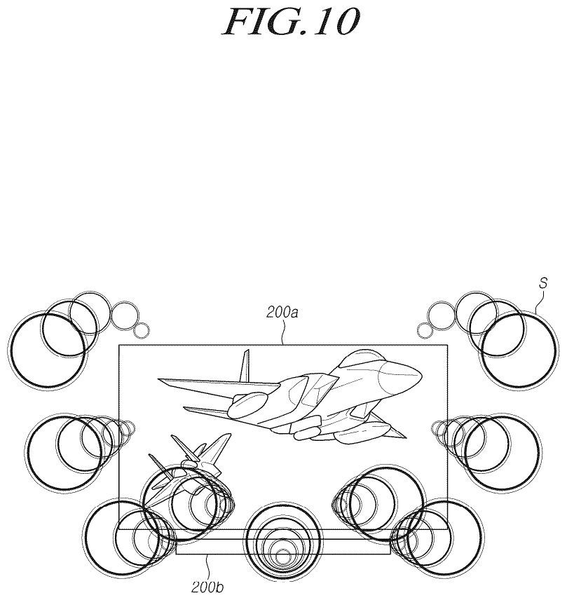

FIG. 10 is a diagram illustrating an example method for an electronic device to use separated object audio data according to various embodiments.

Referring to FIG. 10, an electronic device 200a (e.g., the electronic device 101 of FIG. 1, the electronic device 200 of FIG. 2) may provide sound rendering using object audio data obtained through an object separation model (e.g., the object separation model 221 of FIG. 2).

According to an embodiment, the electronic device 200a may use the object audio data to output sound suitable for content (e.g., video content) provided (e.g., displayed) by the electronic device 200a. For example, the electronic device 200a (e.g., a display device such as a TV) may process (e.g., mixing process) the object audio data separated into voice, music, and effect to be output at different ratios from the electronic device 200a and an external electronic device 200b (e.g., a sound device such as a sound bar) connected to the electronic device 200a. As an example, as illustrated in FIG. 10, in case that a fighter jet video is provided through the electronic device 200a, the electronic device 200a may process the fighter jet effect sound(S) to be rendered in the direction of the fighter jet in the fighter jet video through the electronic device 200a and/or the external electronic device 200b connected to the electronic device 200a, thereby maximizing the sense of presence for the actual fighter jet. As such, the electronic device 200a may provide immersive sound to the user using the separated object audio data.

Effects obtainable from the disclosure are not limited to the above-mentioned effects, and other effects not mentioned may be apparent to one of ordinary skill in the art from the description.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
memory including at least one storage medium storing instructions; and
at least one processor, comprising processing circuitry, wherein at least one processor, individually and/or collectively, is configured to cause the electronic device to:
pre-process input audio data to obtain input data of an object separation model;
input the input data to the object separation model to obtain mask data for a plurality of objects; and
generate object audio data for the plurality of objects using the mask data for the plurality of objects, wherein the pre-processing of the input audio data includes:
converting the input audio data to a frequency domain to obtain first frequency domain data having a first number of frequency bins; and
converting the first frequency domain data to second frequency domain data having a second number of frequency bins less than the first number of frequency bins using a designated conversion algorithm, wherein the second frequency domain data is input to the object separation model as the input data.

2. The electronic device of claim 1, wherein the converting to the second frequency domain data includes applying a second frequency resolution higher than a first frequency resolution to frequency bins having a frequency equal to or higher than a reference frequency among frequency bins of the first frequency domain data, and
wherein the first frequency resolution is a frequency resolution applied to frequency bins having a frequency lower than the reference frequency among the frequency bins of the first frequency domain data.

3. The electronic device of claim 1, wherein the converting to the second frequency domain data includes applying a designated conversion function to frequency bins having a frequency equal to or higher than a reference frequency among frequency bins of the first frequency domain data, and
wherein the conversion function is set based on the reference frequency, the first number of frequency bins, the second number of frequency bins, and a first frequency resolution, wherein the first frequency resolution is set to a value obtained by dividing a sampling rate of the input audio data by a fast Fourier transform (FFT) size.

4. The electronic device of claim 2, wherein the reference frequency is set based on a frequency band of a first object corresponding to voice among the plurality of objects.

5. The electronic device of claim 1, wherein fast Fourier transform (FFT) is used for the conversion to the frequency domain, and
wherein the first number of frequency bins is half of an FFT size of the FFT, and the second number of frequency bins is half of the first number of frequency bins.

6. The electronic device of claim 1, wherein the object separation model corresponds to a U-Net model having a skip connection structure, and wherein the skip connection structure includes an output value of each stage of an encoder connected to a corresponding stage of a decoder.

7. The electronic device of claim 6, wherein the object separation model has a single input/output structure.

8. The electronic device of claim 6, wherein the object separation model includes at least one one-dimensional (1D) convolution layer, at least one 1D-transpose (1D-Tr) convolution layer, and a long short-term memory (LSTM) layer.

9. The electronic device of claim 6, wherein the object separation model comprises an on-device model stored in the memory, and a time duration of the input audio data is set to a value less than 50 ms.

10. The electronic device of claim 1, wherein the generating of the object audio data for the plurality of objects includes:
recovering each mask data having the second number of frequency bins using a designated recovery algorithm to obtain each recovered mask data having the first number of frequency bins; and
multiplying the first frequency domain data by each of the recovered mask data to generate the object audio data for the plurality of objects respectively, and
wherein the plurality of objects include at least one of a first object corresponding to voice, a second object corresponding to music, or a third object corresponding to effect.

11. A method of operating an electronic device, the method comprising:
pre-processing input audio data to obtain input data of an object separation model;
inputting the input data to the object separation model to obtain mask data for a plurality of objects; and
generating object audio data for the plurality of objects using the mask data for the plurality of objects, wherein the pre-processing of the input audio data includes:
converting the input audio data to a frequency domain to obtain first frequency domain data having a first number of frequency bins; and
converting the first frequency domain data to second frequency domain data having a second number of frequency bins less than the first number of frequency bins using a designated conversion algorithm, wherein the second frequency domain data is input to the object separation model as the input data.

12. The method of claim 11, wherein the converting to the second frequency domain data includes applying a second frequency resolution higher than a first frequency resolution to frequency bins having a frequency equal to or higher than a reference frequency among frequency bins of the first frequency domain data, and
wherein the first frequency resolution is a frequency resolution applied to frequency bins having a frequency lower than the reference frequency among the frequency bins of the first frequency domain data.

13. The method of claim 11, wherein the converting to the second frequency domain data includes applying a designated conversion function to frequency bins having a frequency equal to or higher than a reference frequency among frequency bins of the first frequency domain data,
wherein the conversion function is set based on the reference frequency, the first number of frequency bins, the second number of frequency bins, and a first frequency resolution, wherein the first frequency resolution is set to a value obtained by dividing a sampling rate of the input audio data by a fast Fourier transform (FFT) size.

14. The method of claim 12, wherein the reference frequency is set based on a frequency band of a first object corresponding to voice among the plurality of objects.

15. The method of claim 11, wherein fast Fourier transform (FFT) is used for the conversion to the frequency domain, and
wherein the first number of frequency bins is half of an FFT size of the FFT, and the second number of frequency bins is half of the first number of frequency bins.

16. The method of claim 11, wherein the object separation model corresponds to a U-Net model having a skip connection structure, and wherein the skip connection structure includes a structure in which an output value of each stage of an encoder is connected to a corresponding stage of a decoder.

17. The method of claim 16, wherein the object separation model has a single input/output structure.

18. The method of claim 16, wherein the object separation model includes at least one one-dimensional (1D) convolution layer, at least one 1D-transpose (1D-Tr) convolution layer, and a long short-term memory (LSTM) layer.

19. The method of claim 16, wherein the object separation model comprises an on-device model stored in the memory, and a time duration of the input audio data is set to a value less than 50 ms.

20. The method of claim 11, wherein the generating of the object audio data for the plurality of objects includes:
recovering each mask data having the second number of frequency bins using a designated recovery algorithm to obtain each recovered mask data having the first number of frequency bins; and
multiplying the first frequency domain data by each of the recovered mask data to generate the object audio data for the plurality of objects respectively, and
wherein the plurality of objects include at least one of a first object corresponding to voice, a second object corresponding to music, or a third object corresponding to effect.
